(19) United States
(12) Patent Application Publication
(10) Pub. No.: US 2020/0204673 A1
(43) Pub. Date: Jun. 25, 2020

(54) INTERNET OF THINGS USER INTERFACE SIMPLIFICATION

(71) Applicant: ARRIS Enterprises LLC, Suwanee, GA (US)

(72) Inventors: Jeyakumar Barathan, Bangalore (IN); Anil Kumar Nellore, Bangalore (IN); Ravikumar Rajashekhar Patil, Belagavi (IN); ChandraShekar Ksheerasagar, Bangalore (IN); Krishna Prasad Panje, Bangalore (IN)

(21) Appl. No.: 16/227,627

(22) Filed: Dec. 20, 2018

(51) Int. Cl. H04M 1/725; H04W 4/33; H04W 4/02; H04L 12/28; G06F 3/0346; G06F 3/0482; G06F 3/0484

(52) U.S. Cl. CPC H04M 1/72533; H04W 4/33; H04W 4/026; H04L 2012/2841; G06F 3/0346; G06F 3/0482; G06F 3/0484; H04L 12/282

(57) ABSTRACT

A user interface (UI) enables a user to wirelessly control one or more Internet of Things (IoT) devices in a home or office from a mobile device. An IoT protocol is configured to discover and identify IoT devices and generate a visual identifier for each IoT device. An Indoor Positioning System (IPS) protocol is configured to generate a location for each IoT device when the mobile device is pointed toward each IoT device. An orientation sensor protocol is configured to generate orientation sensor data of the mobile device as it points to each IoT device. An IoT device profile is generated and stored for each IoT device comprising one or more of IPS and orientation data. A filtering module collects real-time IPS and orientation data and compares same to the IoT device profile to generate a match. The mobile device displays the IoT device's visual identifier and control options.

### FIELD

This disclosure relates to Internet of Things (“IoT”) devices; and more particularly, to methods and apparatus that simplify user interfaces for the IoT device control.

### BACKGROUND

Mobile applications/apps currently developed for IoT devices frequently utilize complex user interfaces (UI) in order to select and interact with the IoT devices. Since there are typically several IoT devices a user must manually select an IoT device by navigating through a list of IoT devices in a UI provided by IoT applications to use it. To make this more complex, there are many IoT applications where the user must utilize a specific mobile app for controlling specific IoT devices.

Voice-based IoT control mechanisms are available for managing of IoT apps. For nonlimiting example, one such voice-based virtual assistant is that associated with the trade name Amazon Alexa. These devices are capable of using voice control for playing music, creating reminder lists, streaming media, alarms, and providing real-time information. Through control of several smart devices voice-based IoT assistants provide a home automation system wherein users can extend the capabilities by installing apps. However, voice-based control cannot be used in all use-cases, and therefore its capabilities are limited. Sometimes it is very irritating to use voice control, as it can misinterpret conversations into commands. Other times, misinterpretation occurs because the voice commands must be in a specific format to make the command work. For people who can't speak or who have speech disabilities, voice-based IoT control mechanisms cannot be used. There are also privacy issues, as the device is always in hearing mode and data is sent outside the home for processing.

There are many IoT devices and many IoT protocols, making IoT device control complicated. There exists a need in the art for a simple and better way to control IoT devices. There also exists a need in the art for a method and system that intelligently controls IoT devices using a mobile phone UI simply by pointing at IoT devices.

### BRIEF DESCRIPTION OF THE DRAWINGS

The invention will be more fully understood, and further advantages will become apparent when reference is had to the following detailed description of the preferred embodiments of the invention and the accompanying drawings, in which:

FIG. 1 shows a flowchart illustrating set-up phase steps of an embodiment of the subject method and system;

FIG. 2 shows a flowchart illustrating steps of application usage of an embodiment of the subject method and system;

FIG. 3A shows an environment implementing the subject system and method configurable for providing UI for client IoT control through mobile devices, in an embodiment;

FIG. 3B shows a block diagram of the living room of FIG. 3A, in an embodiment;

FIG. 4 shows IoT device control for a home (using a mobile phone app), in an embodiment;

FIG. 5 shows a diagram of an IoT device identification as a service through a gateway (“GW”) device, in an embodiment;

FIG. 6 shows a flowchart illustrating the initial setup steps of an embodiment of the subject method and system wherein a mobile phone app, and GW device are used;

FIG. 7 shows a flowchart illustrating a service module provided by a GW device, in an embodiment;

FIG. 8 illustrates a control device using compass sensor data, in an embodiment;

FIG. 9 illustrates control devices using orientation sensor data, in an embodiment;

FIG. 10 shows various positioning and orientation data for IoT devices, in an embodiment;

FIG. 11 shows an example of a gateway device that can be implemented in an embodiment;

FIG. 12 is a block diagram of a hardware configuration operable to facilitate the initiation of the subject method and system in an embodiment.

### DETAILED DESCRIPTION

Aspects of the present invention provide methods, systems, and computer readable media operable to control IoT devices using a user interface (UI) on a mobile device, particularly a mobile phone. The UI with the aid of mobile phone orientation sensors and indoor positioning system allows simplified control of the IoT devices. The mobile phone can be used to point at an IoT enabled device and control it using the available options displayed on the screen. Using the sensors in the mobile phone, the system and method determine which IoT device the mobile device is pointing to in the given location. Indoor positioning system data (using Wi-Fi) combined with compass and orientation sensor data is used to narrow down and to identify the device that the mobile phone is pointing to.

In a first aspect of an embodiment, a user interface (UI) is provided for enabling a user to wirelessly control one or more Internet of Things (IoT) devices in a home or office from a mobile device. The UI includes an IoT protocol configured to discover and identify IoT devices in the home or office and generate a visual identifier for each IoT device. An Indoor Positioning System (IPS) protocol configured to generate a location for each IoT device when the mobile device is pointed toward each IoT device being used by the UI. The UI also includes an orientation sensor protocol configurated to generate orientation sensor data of the mobile device as it points to each IoT device. An IoT device profile is generated and stored for each IoT device comprising one or more of IPS and orientation sensor data. A filtering algorithm is executed in a filtering module to collect real-time IPS and orientation sensor data and compare the data to the IoT device profile to generate a match for selecting one of the IoT devices for control options. The UI causes the mobile device to display the visual identifier and control options for the selected IoT device so that the user can control the IoT device through the mobile device.

Another aspect of an embodiment is directed toward a method implemented by a user interface (UI) for enabling a user to wirelessly control one or more Internet of Things (IoT) devices in a home or office from a mobile device, comprising the steps of: a. configurating an IoT protocol to discover and identify IoT devices in the home or office and generate a visual identifier for each IoT device; b. implementing an Indoor Positioning System (IPS) protocol to generate a location for each IoT device when the mobile device is pointed toward each IoT device; c. applying an orientation sensor protocol configured to generate orientation sensor data of the mobile device as it points to each IoT device; d. generating and storing an IoT device profile for each IoT device one or more of IPS and orientation sensor data; e. executing filtering algorithm executable to collect real-time IPS and orientation sensor data and compare the data to the IoT device profile to generate a match for selecting one of the IoT devices for control options. The UI causes the mobile device to display the visual identifier and control options for the selected IoT device so that the user can control the IoT device through the mobile device.

In another aspect of an embodiment, there is provided one or more non-transitory computer readable media having instructions operable to enable a user interface (UI) to allow a user to wirelessly control one or more Internet of Things (IoT) devices in a home or office from a mobile device. The media has instructions operable for: a) configurating an IoT protocol to discover and identify IoT devices in the home or office and generate a visual identifier for each IoT device; b) implementing an Indoor Positioning System (IPS) protocol to generate a location for each IoT device when the mobile device is pointed toward each IoT device; c) applying an orientation sensor protocol configured to generate orientation sensor data of the mobile device as it points to each IoT device; d) generating and storing an IoT device profile for each IoT device comprising one or more of IPS and orientation sensor data; e) executing filtering algorithm executable to collect real-time IPS and orientation sensor data and compare the data to the IoT device profile to generate a match for selecting one of the IoT devices for control options; whereby the UI causes the mobile device to display the visual identifier and control options for the selected IoT device so that the user can control the IoT device through the mobile device.

It is desirable to improve upon methods and systems for controlling IoT enabled devices. The subject system, method, and computer readable media is operable to control IoT devices using a mobile phone user interface (UI) implementing mobile phone orientation sensors and indoor positioning system. Control of IoT devices is operable using the subject system and method implementing on as a mobile phone user interface used to point at an IoT enabled device and cause its position and the related mobile phone orientation to be stored and extrapolated later for IoT device control using the available options shown in the screen. Combining orientation sensor data using the sensors in the mobile phone and indoor positioning system (IPS) data, the subject system and method narrows down and identifies the IoT device the mobile phone is pointing to and allows IoT control of that device.

Throughout this application the term “user” is used, which generally herein refers to a client, the end user, or consumer using one or more IoT enabled device/viewer receiving IoT enabled device services. Mobile device refers to mobile phones, such as smartphones, and/or may also refer to tablets and/or laptops having Wi-Fi and/or Bluetooth capability. As used herein the term gateway (GW) refers generally to a data communication device that provides a remote network with connectivity to a host network, a device that routes traffic from a workstation to the outside network, an ISP that connects a user to the internet, and/or a proxy server and a firewall. Access Point (AP) or wireless access point (WAP) as used herein generally refers to a networking hardware device that permits a Wi-Fi device to connect to a wired network, typically connecting to a router (via a wired network) as a standalone device, or integral to the router itself. Set top box (STB)/Station (STA) as used herein generally refers to a set top box, station, receiver, and/or an access point (AP) communicating via protocol, particularly the 802.11 protocol. Bluetooth Low Energy (BLE) generally refers to a wireless personal area network technology.

The subject apparatus and method provides an IoT user interface for simplified ways to control IoT devices using mobile phone user interfaces with the aid of mobile phone orientation sensors and indoor positioning systems. Implementing a mobile device, particularly a mobile phone, the subject system and method controls IoT devices through the user interface. The mobile phone is used to point an IoT enabled device location, filter IoT devices based on location parameters and match a selected IoT device. Upon a match, the UI displays available options on the mobile phone screen for control of the IoT device. During user set-up indoor positioning system data is utilized in conjunction with compass and orientation sensor data of the mobile phone device to assign a location for each IoT device, IoT devices 1, 2, 3, . . . (n+1). Each IoT device is assigned a location and orientation data for identifying an IoT device enabling control through the UI installed on the mobile phone device.

Using mobile phone orientation sensors, the UI matches the given location the mobile device is pointing to and filters the location with the IoT device locations determined at set-up. Indoor positioning system data, preferably using Wi-Fi, Bluetooth technology, and/or Gateway protocol, combined with compass and orientation sensor data of the mobile phone device is used to narrow down and to identify the IoT device that the mobile phone is pointing to.

The UI allows for different implementations of IoT device control. In a first aspect of an embodiment, the UIT allows pairing of the UI of the mobile device, or mobile phone, with different IoT devices based on orientation and position information of the IoT device, utilizing filtering and matching of a IoT device using UI services downloadable to a mobile phone. Gateway protocols may be implemented for filtering IoT devices based on orientation and position information, for simpler UI based on context. Alternatively, hybrid solutions involving mobile phone application and Gateway protocols may be used to control IoT devices in the home.

Android/iOS app/software for clients is required for download by clients to facilitate the UI for IoT control.

The UI can be implemented and executed on logic operable through the mobile device, which preferably is a mobile phone. Alternatively, the UI is implemented through a GW controller configured to establish a wireless streaming session between one or more access point and the mobile phone for generating the IoT device profile and executing the filtering algorithm. In one aspect, the filtering algorithm uses orientation sensor data to filter the IoT device. In another aspect, the filtering algorithm uses IPS data to filter the IoT device, wherein the IPS data is used to identify the IoT device in a room in the home or office. In yet another aspect, the filtering algorithm uses IPS data and orientation sensor data to filter the IoT device providing a position A with orientation X.

Indoor positioning systems (IPS) are used to locate objects or people inside a structure through mobile device collection of sensory information, lights, radio waves, magnetic fields, or acoustic signals. IPS uses a variety of technologies, including distance measurement in relation to nearby anchor nodes or nodes with known fixed positions through Wi-Fi/Li-Fi access points or Bluetooth beacons, and/or magnetic positioning. IPS either actively locates mobile devices and tags or provide ambient location or environmental context for devices to get sensed. Typically, at least three independent measurements, trilateration, are needed to unambiguously find a location. Detecting the device's orientation or compass direction is used to disambiguate from smartphone vertical orientation.

Wireless technology is preferably used by the subject system and method for indoor positioning of IoT devices. In conjunction with IPS, mobile phone sensors including compass sensors for direction finding and orientation sensors (allowing for phone orientation change) are used. Wi-Fi and Bluetooth based indoor positioning systems are utilized by the UI so that the mobile phone user can be identified with a specific indoor location Wi-Fi-based positioning system (WPS) can be used in the subject system and method for positioning with wireless access points, via mobile phone device and/or gateway devices, through measuring the intensity of the received signal or received signal strength and fingerprinting. Wi-Fi hotspot or wireless access point and the SSID and the MAC address of the access point are typically used a parameters. Alternatively, Bluetooth can be used, including Bluetooth LE.

Filtering of IoT devices can be done in multiple ways depending on the application usage. For example, the compass sensor data can be used to filter the device based on the direction. Orientation sensor data can be used to filter the device based on phone orientation if there are more than one device in that direction. Also, position data from IPS can be used in two ways. One way is to simply use it as a context, where position data identifies that IoT device is in living room, bedroom etc. The second way is to use it for device identification, as a position A with orientation X provides a device that is different than a position B with the same orientation X. It can also happen that Position A with orientation X and Position B with orientation Y could be pointing to the same device.

The tilt of the mobile phone can be used to switch context. Suppose there are many devices available (example: TV/STBs) and a mobile phone app is operable to control them. Usually, using an IR, the commands will be sent to all devices. Using Bluetooth, commands are instead sent to a specific IoT device. But, in this case the device is manually selected from a displayed list on the mobile device. In using this mobile phone orientation-based approach, the user can simply tilt the phone to select the device and start the control. It also allows easy switching between devices, as it is just pointing the mobile phone to the desired device. These applications can be particularly useful in showrooms or office spaces where there are lot of devices.

Direction based instant Bluetooth device pairing can be used by the subject system and method. Consider there are multiple Bluetooth devices available and a user wants to pair to a Bluetooth device. Usually, the user needs to identify the device based on name and pair it. Nowadays, BLE devices are available where pairing can happen based on proximity. The subject system and method utilizes direction-based pairing, where the mobile phone orientation is used to filter the devices and pair it.

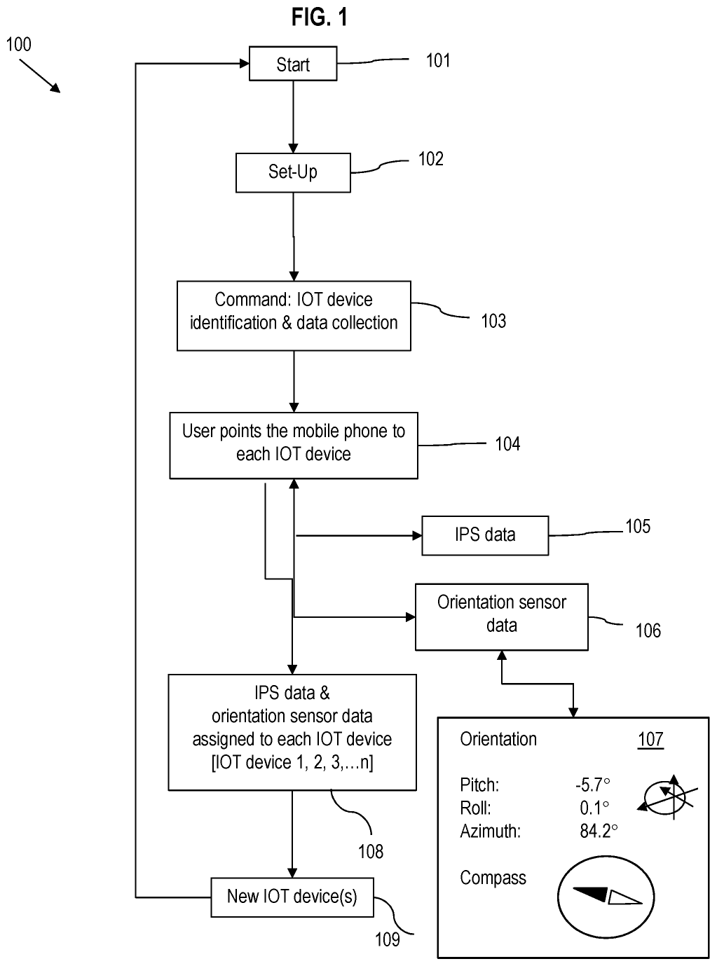

FIG. 1 is a flowchart illustrating set-up phase steps of an embodiment of the subject method and system, shown generally at 100. A mobile phone application is provided that utilizes an App to control IoT devices using IoT protocols. A user in a home or indoor location starts the IoT mobile phone app/UI downloaded onto the mobile phone at 101 and runs setup at 102. During setup, the App identifies IoT devices in the home. These devices may include, for nonlimiting example, fans, lights, thermostats, televisions, security systems like fans/lights/TVs, etc. IoT device discovery can be accomplished in many ways, as there are different IoT protocols. For example, IoT device discovery can be accomplished using OIC protocol for device-to-device connectivity, such as that associated with the trade name loTivity sponsored by Open Connectivity Foundation (OCT). At 103 the App commands execution of IoT device identification and data collection and asks the user to point to each of the IoT devices at 104. The user points the mobile phone to each device.

As the user points the mobile phone to each IoT device [IoT device 1, 2, 3, . . . n] the App collects IPS data at 105 to get the context of the indoor location (living room, bedroom) and the orientation sensor data at 106. An IoT device profile is generated, preferably formed as a data table, and is stored listing each IoT device. This IoT device profile preferably includes one or more of IPS and orientation sensor data. An example of a screenshot of the mobile device is shown generally at 107 as the mobile device's orientation sensor data determines pitch, roll and azimuth utilizing the compass tool. IPS data and orientation sensor data is assigned to each IoT device [IoT device 1, 2, 3 . . . n] at 108. This data is stored for later use in identifying IoT devices. The same steps are repeated when adding a new device, as shown at 109.

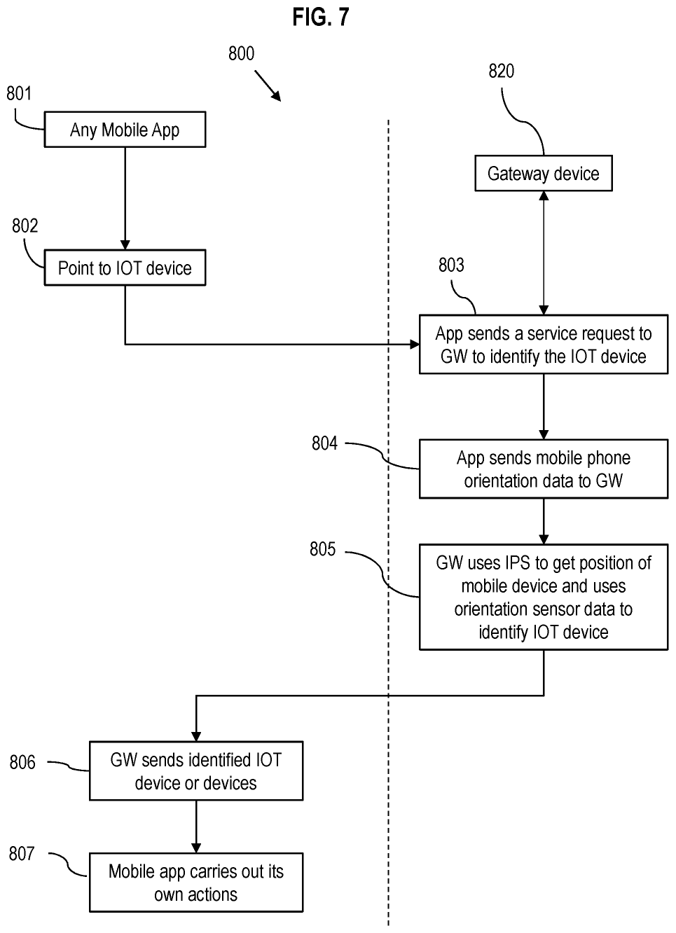

The UI can be implemented and executed on logic operable through the mobile device, which preferably is a mobile phone. Alternatively, the UI is implemented through a GW controller configured to establish a wireless streaming session between one or more access point and the mobile phone for generating the IoT device profile and executing the filtering algorithm. In one aspect, the filtering algorithm uses orientation sensor data to filter the IoT device. In another aspect, the filtering algorithm uses IPS data to filter the IoT device, wherein the IPS data is used to identify the IoT device in a room in the home or office. In yet another aspect, the filtering algorithm uses IPS data and orientation sensor data to filter the IoT device providing a position A with orientation X (see, for example, FIGS. 8-10 discussed hereinafter).

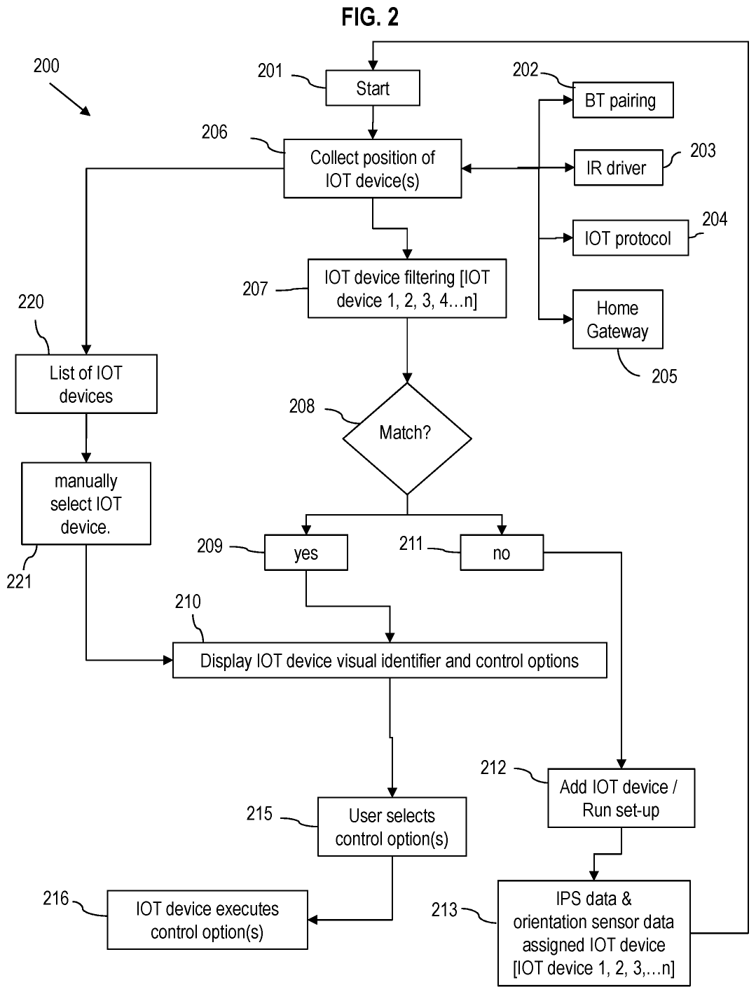

FIG. 2 is a flowchart illustrating steps of application usage of an embodiment of the subject method and system, shown generally at 200. Application usage Following steps are done after the initial setup is completed. At 201 the user starts the mobile phone application. The user points the mobile phone device to the IoT device that the user wishes to control at 202. These may include, for nonlimiting example, lights, fans, thermostats (AC/heat), which locations have been entered and stored during the set-up phase. At 206, the App collects the position from IPS and orientation sensor data based on the pointing of the mobile phone. At 207 the App executes filtering of the closest IoT device(s) that correspond to saved IPS and orientation data corresponding to a given IoT device.

At 208 the App queries whether there is a match of the IPS and orientation data corresponding to the pointing location. If yes, at 209, the App displays a visual identifier of the IoT device and displays related control options at 210. The IoT device visual to App displays the visual identifier of the device and provides control. For example, if user points to a light bulb, app displays a light bulb picture and controls such as ON/OFF. If the user points to a ceiling fan, the app displays a fan picture and controls such as ON/OFF and increase/decrease speed.

The user then selects the control option, as shown at 215. At 216, upon entry of the control command, the IoT device executes the elected control option.

If no match is found at 208, then the no, at 211, causes the App to query or prompt the user to add IoT device/run set-up at 212. After set-up is executed (FIG. 1) the IoT device is assigned IPS data and orientation sensor data, at 213. At which point, the user is redirected to start the control process at 201.

The control of IoT device can be accomplished in multiple ways, including BT pairing 202, IR driver 203, IoT protocol 204 and/or through the home Gateway 205. Direct control can be provided when the user points the phone to a device that support BT, BT pairing 202 takes place and the display immediately allows control of that device. On the other hand, when the user points the phone to an IR device (which doesn't provide access through network), an IR driver 203 is used for direct control through the mobile device. When the user points the mobile phone to a device which can be controlled through an IoT protocol, that IoT protocol 204 is used to control the device (control using IoT protocol). When the user points the phone to a device which can be controlled through the Home Gateway 205 (that provides common interface and controls the IoT device due to nature of fragmentation of IoT protocols and control mediums like BT, ZigBee, Wi-Fi, etc.), the control is done through the GW defined protocol (control using Gateway device).

Alternatively, after collecting the position of the IoT device at 206, a list of IoT devices appears on the mobile phone's display screen at 220. At 221 the user may manually select the IoT device. Display of the IoT device visual identifier and control options are provided at 210 for user control.

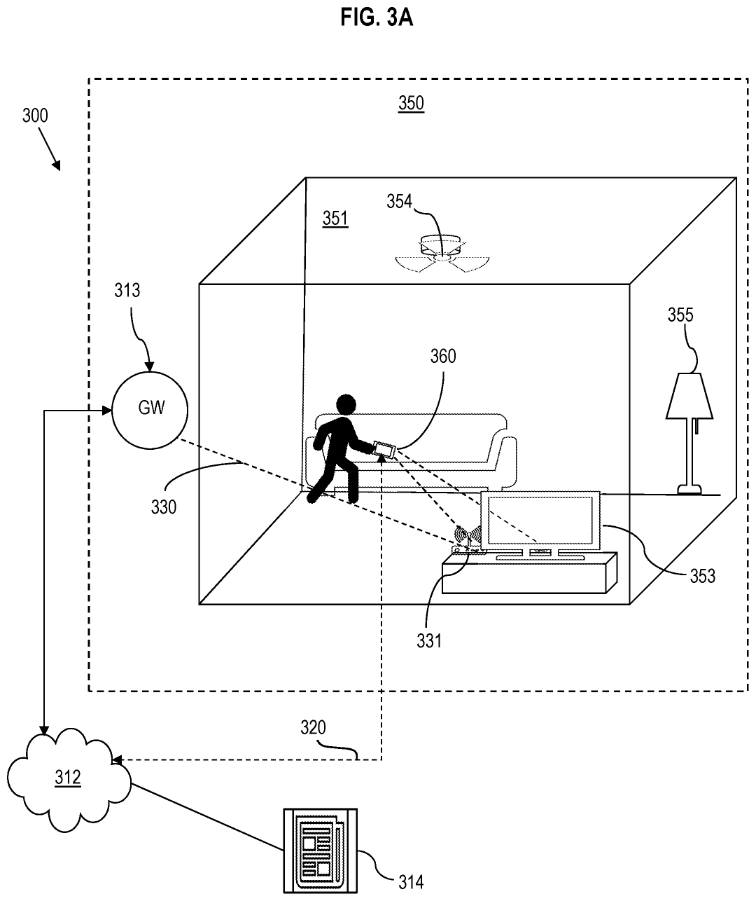

FIG. 3A shows an environment implementing the subject system and method configurable for providing UI for client IoT control through mobile devices, shown generally at 300. GW of the home, office, hospital, mall or business, shown generally at 313, in communication with a wide area network (WAN) 312 which preferably communicates with a GW server 314 (typically via the service provider). The GW may include HNC protocols, preferably utilizing CWMP protocol stack supporting TR-157 Amendment 10 and TR-181 Issue 2 Amendment 10 support for efficient bulk data transmission to the ECO Wi-Fi Cloud. One or more Home Network Extender protocol (HNE) servers may be provided which operate on the GW 313 implementing the HNC platform and software, and/or GW protocol.

For representative example, a living room 351 in a home is shown at 350. Living room 351 includes IoT enabled devices, herein router/GW IoT device 1 at 331/313, television and STB IoT device at 353′ device 2 at 353, fan IoT device 4 at 354, and light/bulb IoT device 4 at 355. During set-up, each of the IoT devices 1, 2, 3, 4 at 352, 353, 354 and 355 are pointed at by a user with a mobile device(s) 360 (preferably being a mobile phone or tablet). During set-up, the App stores an associated indoor position of the IoT devices and stores orientation data associated with the mobile device 360. Each IoT device 1, 2, 3, 4 at 352, 353, 354 and 355 is assigned an IPS/orientation data. For example, IoT device 1 at 352 data found at: IoT device 1: orientation—Pitch −5.7°, Roll 0.1°, Azimuth 84.2°; compass IPS:(DMS): 41° 24′12.2″N 2° 10′26.5″E; IoT device 2: orientation—Pitch −1.7°, Roll 0.3°, Azimuth 102°; compass IPS:(DMS): 40° 25′14.2″N 5° 12′24.5″E; . . . etc.

The App populates a data table correlating each IoT enabled device with an IPS and mobile device orientation data and stores this data on the server 314. In the example shown, when user mobile phone 360 points to the television and STB IoT device 2 at 353, 353′ the App/GW collects the real-time IPS and orientation data and compares that real-time data to the stored IPS and orientation data for the uploaded IoT devices, filtering out devices and selecting a match. Herein, IPS and orientation of the mobile phone 360 matches IoT device 2 at 353 for IoT control through the mobile phone 360. In the FIG. shown, IoT control through the mobile device can be provided in a number of ways. IoT control can be executed by mobile phone App execution directly to the WAN 312, as shown at 320. Alternatively, as shown generally at 330, IoT control can be executed by mobile phone App execution in conjunction with GW device (AP/STA 331), such as when the IoT device identification is part of a service, providing a hybrid solution involving a mobile phone app and GW device. In other applications, the GW can be utilized for synchronizing IPS and orientation assignment for IoT devices downloadable to the mobile device for IoT control. GW devices can include one or more, for nonlimited example, AP, WAP, and/or STA, shown generally at 331.

FIG. 3B shows a block diagram of the living room of FIG. 3A, shown generally at 370. IoT devices shown include fan 354, STB 353′, TV 353, and lamp/light bulb 355 in a living room. The mobile phone is used to control the IoT devices, showing in phantom the mobile phone capabilities based on compass/orientation sensors, shown at Position 1 360a, Position 2 360b, Position 3 360c and Position 4 360d. Wi-fi Router/Gateway device 331, 313 provides Indoor Positioning System functions. Different UI is displayed in the mobile phone, based on where the mobile phone is pointing to (Note the options shown to user vary depending on device selected), via Position 1 360a, Position 2 360b, Position 3 360c and Position 4 360d.

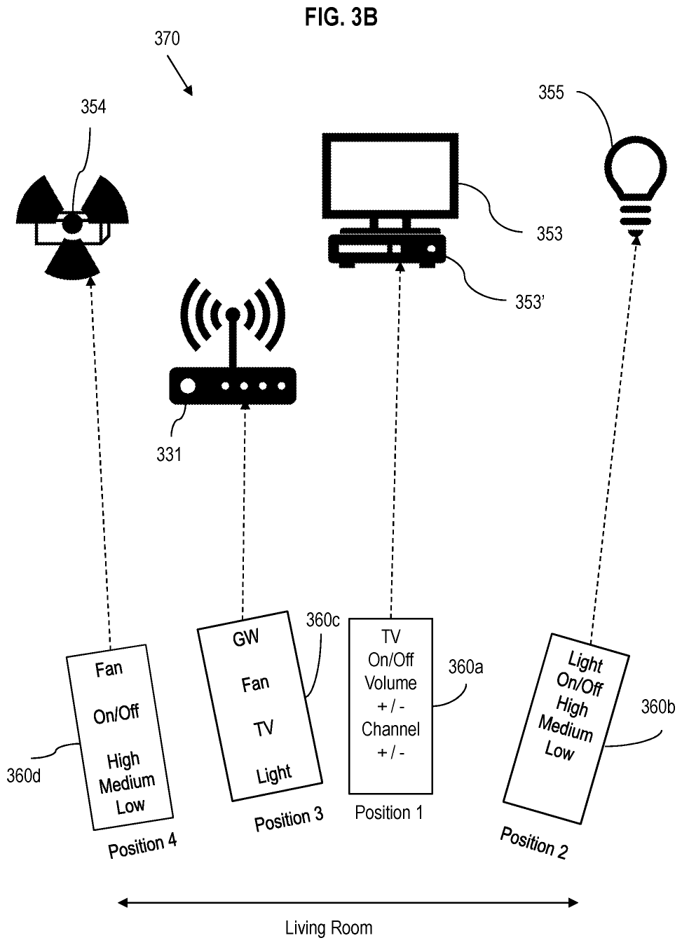

FIG. 4 shows IoT device control—home (using mobile phone app), shown generally at 400. A mobile phone application 401 is developed utilizing IoT device identification protocols, configurations 402 and control 403 stored in a database. The App 401 controls IoT devices using IoT protocols as entered during set-up. In this aspect of an embodiment, the App/app/application runs on the mobile phone. The App 401 is downloaded on the mobile phone/device as shown at 405. The mobile device 405 includes sensors for orientation, and wireless capabilities including Bluetooth and Wi-Fi. Through Wi-Fi, the mobile phone 405 communications with the GW 410 which includes BT and Wi-Fi technologies, as well as IPS protocol and IoT1 and IoT2.

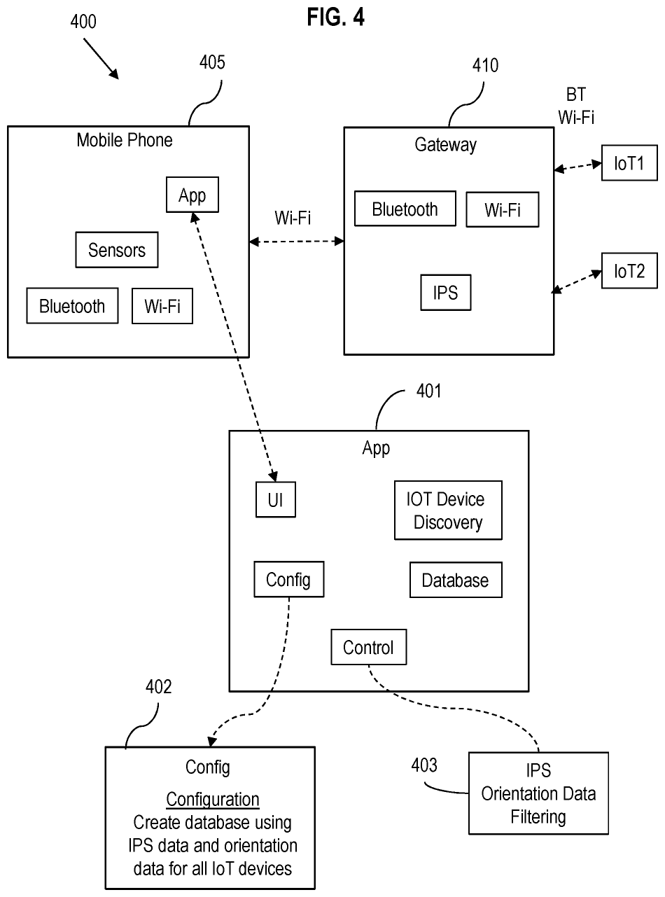

FIG. 5 shows a diagram of an IoT device identification as a service through a GW device, shown generally at 500. This aspect of an embodiment provides a hybrid solution involving mobile phone app and one or more GW device. Implementation of gate-way 510 is provided instead of having the mobile phone application to have the logic to identify the IoT device. Preferably, this can be made a service by an internet provided. The service can be provided with the help of Wi-Fi Gateway devices, which exist in homes. The service can be used by any mobile application. Applications can be written based on service events, which indicates the IoT device that the mobile phone is pointing to. GW 510 is in communication with mobile phone 505 and includes a gateway app 501 with configuration 502 and control 503 protocols. GW App 501 interacts with a mobile app 512 to provide IPS and orientation data to the GW 510.

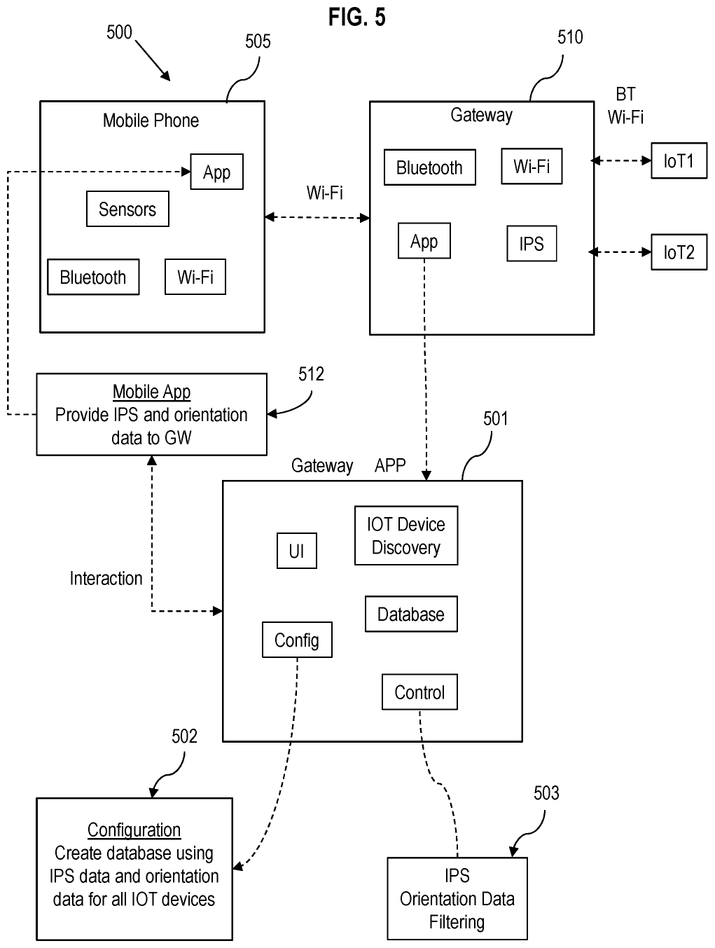

FIG. 6 is a flowchart illustrating initial setup steps of an embodiment of the subject method and system wherein a mobile phone app and GW device are used, shown generally at 600. In this embodiment, IoT device identification is part of a service, providing a hybrid solution involving a mobile phone app and GW device. GW devices can include one or more, for nonlimited example, AP, WAP, and/or STA implemented through a home network, including those operating on HNC platform and software. GW protocol enables synchronizing Wi-Fi configuration and transmitting statistical information that can be stored and used in determining IoT device selection. At 601 the mobile App runs set-up mode. The App discovers IoT devices at 602 using HC and IoT modules 610. Next, at 603 the App asks user to point to the IoT device. At 604 the App sends mobile phone orientation data to the GW device 620. At 605 the AP uses the mobile device's IPS to get position of the mobile device. Next, at 606, the IPS and orientation sensor data of the mobile device is collected and stored through the GW device and AP servers. The steps are repeated for all IoT devices, as shown at 607. In this embodiment, instead of having the mobile phone App/application having the logic to identify the IoT device, IoT device identification can be made a service. The service can be provided with the help of Wi-Fi GW devices in homes. The service could be used by any mobile application. Applications could be written based on service events, which indicates the IoT device that the mobile phone is pointing to. In this embodiment, the mobile app runs the setup of associating IoT devices with their indoor location with the help of Wi-Fi GW device(s).

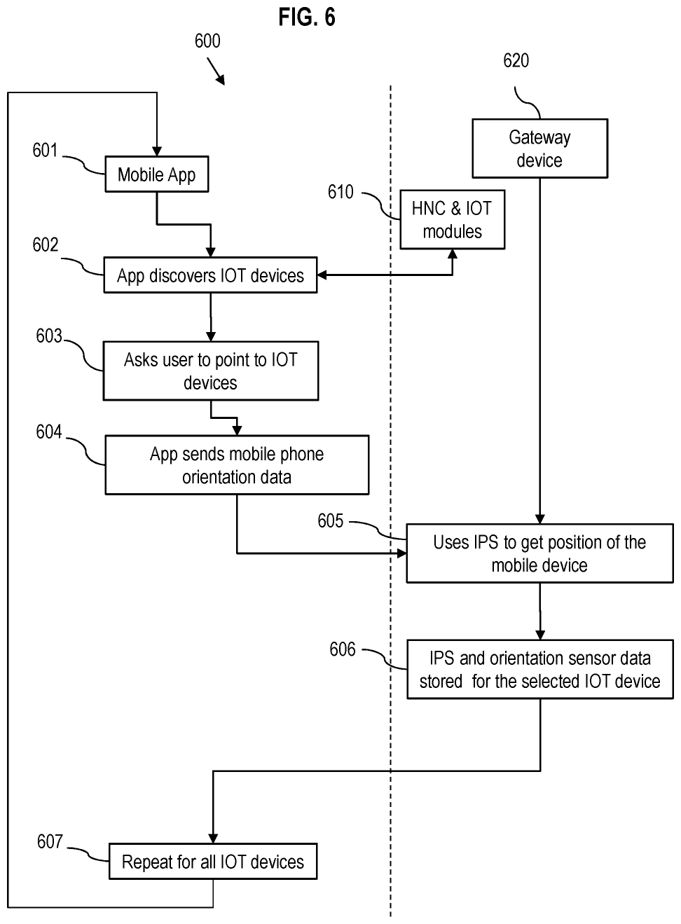

FIG. 7 is a flowchart illustrating a service module provided by a GW device, shown generally at 700. The service model provided by the GW can be utilized by any app running in the mobile phone or in any other device that's interested in this data. At 701, any mobile app can be utilized. Next, at 702, the user points the mobile phone to an IoT device. At 703 and 704, respectively, the App sends a service request to identify the IoT device and mobile phone orientation data to the GW device 720. At 705, the GW uses the IPS to determine the position of the mobile device and compares the orientation sensor data to identify the device pointed to. GW device sends the identified device or devices to the mobile phone, at 706. At 707, the mobile app carries out its own actions. In this way, a service model is provided wherein IoT device identification and filtering is a service provided by the GW based on sensor data and position information. This service approach can be used in many ways. It can be used by an IoT control app to provide a UI that can filter and display IoT devices based on mobile phone orientation. The GW device can provide the service of filtering the IoT device based on orientation and position data. It can be used by a TV/STB control app on the mobile phone to use the service to launch itself, when the user points the mobile phone to TV, based on service events. GW devices can provide service events, like for example «Notify when this device gets pointed to».

FIG. 8 illustrates a control device using compass sensor data. IoT devices 801, 802, 803 and 804 are positioned by way of a compass.

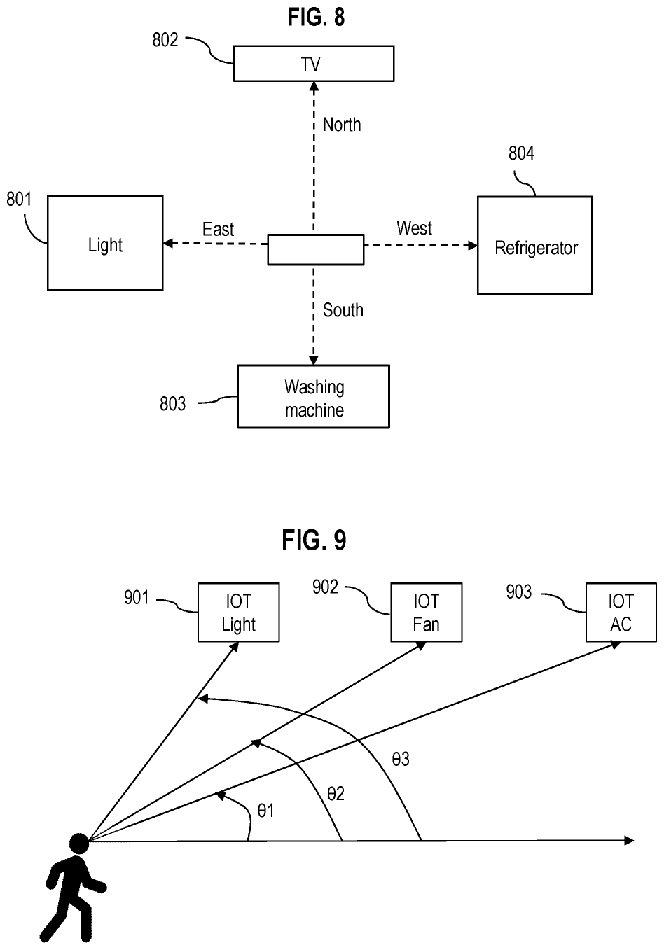

FIG. 9 illustrates control devices using orientation sensor data. IoT devices 901, 902 and 903 are shown having different orientations based on angle θ from a horizontal plane (i.e. plane parallel to the x-axis or the ground surface/floor).

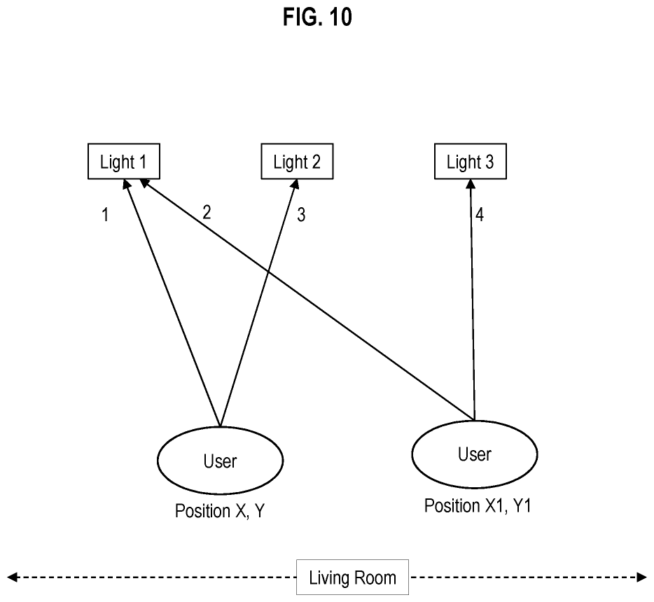

FIG. 10 shows various positioning and orientation data for IoT devices.

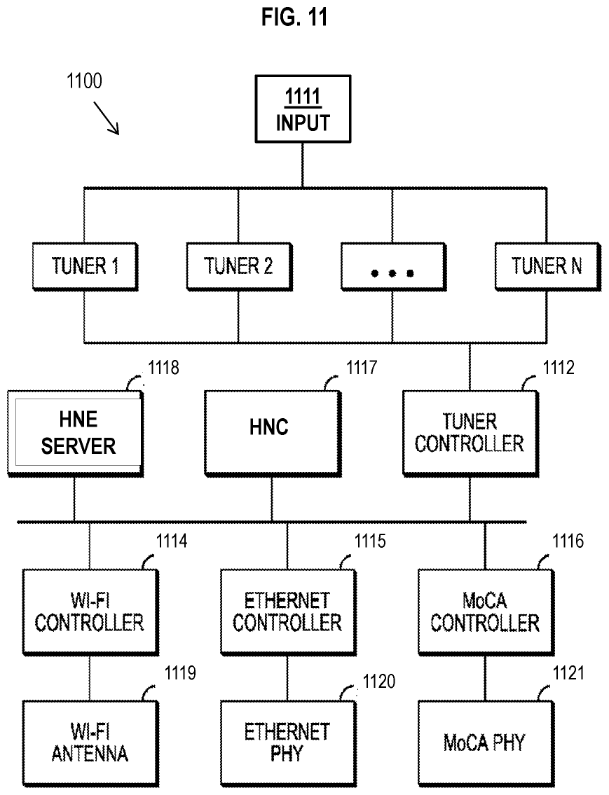

FIG. 11 shows an example of a gateway device, for example HNC protocol, of the present invention, shown generally at 1100. The gateway device is a content streaming apparatus that is a gateway to content, data, and any information accessible through signals on input 1111. The input 1111 may be an RF input that connects to a content provider, such as a television program provider, by terrestrial antenna, satellite dish, or wired cable. The gateway device includes a plurality of tuners, Tuner 1, Tuner 2, . . . Tuner N, each of which selectively tunes to a requested frequency or channel of content. A Tuner Controller 1112 controls each tuner to tune to an instructed frequency or channel. The Tuner Controller 1112 also determines whether an unused tuner is available, and if so, reserves a tuner as a destination tuner during a transfer of a streaming session from another gateway device.

The gateway device includes one or more HNE 1118 server, which could be implemented by an integrated circuit or circuits or by a processor that converts content signals from the tuners to appropriate signals for wireless (e.g. Wi-Fi or LTE) transmission via the wireless controller 1114 and wireless antenna 1119. The gateway device includes an Ethernet controller 1115 and/or a MoCA controller 1116 by which the gateway device can be networked with other gateway devices, or any other networking capable device. The Ethernet controller 1115 and the MoCA controller 1116 interface to the network via the Ethernet PHY (physical transceiver) 1120 and MoCa PHY (physical transceiver) 1121, respectively.

The gateway device also includes a Gateway Steering Controller (GSM) or HNC 1117, which monitors streaming sessions on all of the gateway devices in the network, and monitors the signal strength of the client devices. The gateway device can be in the form of a so-called “set-top box,” AP, extender AP, etc., or may be built into a television or other media content playing apparatus.

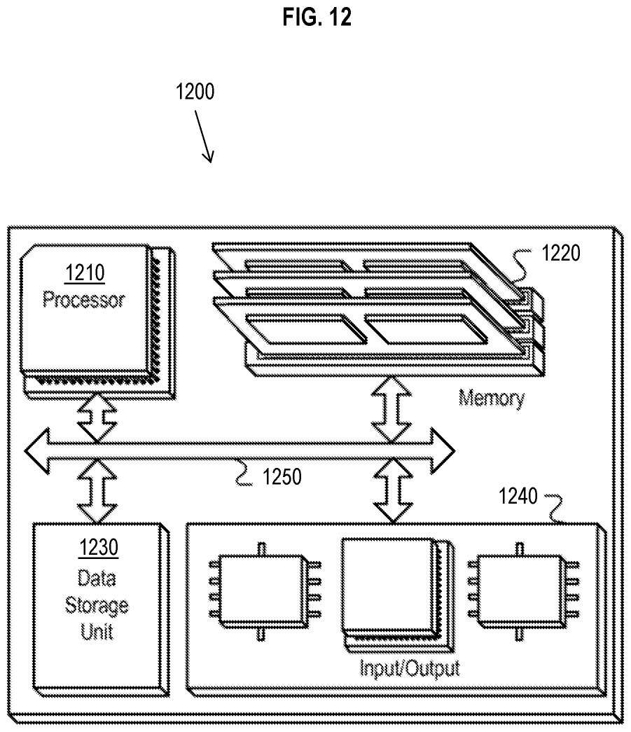

FIG. 12 is a block diagram of a hardware configuration operable to facilitate the initiation of the subject method and system, such as for a set top box or AP/STA, shown generally at 1200. The hardware configuration can include a processor 1210, a memory 1220, a storage device 1230, and an input/output device 1240. Each of the components 1210, 1220, 1230, and can, for example, be interconnected using a system bus 1250. The processor 1210 can be capable of processing instructions for execution of the subject method, system and computer readable media within the hardware configuration 1200. In one implementation, the processor 1210 can be a single-threaded processor. In another implementation, the processor 1210 can be a multi-threaded processor. The processor 1210 can be capable of processing instructions stored in the memory 1220 or on the storage device 1230. The memory 1220 can store information within the hardware configuration 1200. In one implementation, the memory 1220 can be a computer-readable medium. In one implementation, the memory 1220 can be a volatile memory unit. In another implementation, the memory 1220 can be a non-volatile memory unit. In some implementations, the storage device 1230 can be capable of providing mass storage for the hardware configuration 1200. In one implementation, the storage device 1230 can be a computer-readable medium. In various different implementations, the storage device 1230 can, for example, include a hard disk device, an optical disk device, flash memory or some other large capacity storage device.

In other implementations, the storage device 1230 can be a device external to the hardware configuration 1200. The input/output device 1240 provides input/output operations for the hardware configuration 1200. In one implementation, the input/output device 1240 can include one or more of a network interface device (e.g., an Ethernet card), a serial communication device (e.g., an RS-232 port), one or more universal serial bus (USB) interfaces (e.g., a USB 2.0 port), one or more wireless interface devices (e.g., an 1202.11 card), and/or one or more interfaces for outputting video and/or data services to a CPE device (e.g., access point, cable modem, router, wireless extender, or other access device) or subscriber device (e.g., set-top box/station, etc.). In another implementation, the input/output device can include driver devices configured to send communications to, and receive communications from one or more networks (e.g., WAN, local network, cloud, headend/cloud controller, etc.).

Those skilled in the art will appreciate that embodiments improve upon methods and systems for client mobile device IoT control based on IPS and orientation data. The subject matter of this disclosure, and components thereof, can be realized by software instructions that upon execution cause one or more processing devices to carry out the processes and functions described above. Such instructions can, for example, comprise interpreted instructions, such as script instructions, e.g., JavaScript or ECMAScript instructions, or executable code, SoftAp mode pulse timing activation and deactivation instructions, signal strength activation and deactivation software, initial fingerprint (birth certificate) logarithmic and execution instructions, activation signals or software, or other instructions stored in a computer readable medium.

Implementations of the subject matter and the functional operations described in this specification can be provided in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a tangible program carrier for execution by, or to control the operation of, data processing apparatus.

A computer program (also known as a program, software, software application, script, or code) can be written in any form of programming language, including compiled or interpreted languages, or declarative or procedural languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification are performed by one or more programmable processors executing one or more computer programs to perform functions by operating on input data and generating output thereby tying the process to a particular machine (e.g., a machine programmed to perform the processes described herein). The processes and logic flows can also be performed by, and apparatus can also be implemented as, special purpose logic circuitry, e.g., an FPGA (field programmable gate array) or an ASIC (application specific integrated circuit).

Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto-optical disks; and CD ROM and DVD ROM disks. The processor and the memory can be supplemented by, or incorporated in, special purpose logic circuitry.

The present invention may be implemented as any combination of a system, a method, an integrated circuit, and a computer program on a non-transitory computer readable recording medium. The content streaming apparatuses, gateway devices, and/or the GSM may be in the form of an access point, set-top box or other standalone device, or may be incorporated in a television or other content playing apparatus, or other device and the scope of the present invention is not intended to be limited on such forms.

The components of the content streaming apparatuses, gateway devices, and GSM may be implemented as Integrated Circuits (IC), Application-Specific Integrated Circuits (ASIC), or Large Scale Integrated circuits (LSI), system LSI, super LSI, or ultra LSI components which perform a part or all of the functions of the GSM, and gateway devices. Each of the processing units can be many single-function components, or can be one component integrated using the technologies described above. Components may also be implemented as a specifically programmed general purpose processor, CPU, a specialized microprocessor such as Digital Signal Processor that can be directed by program instructions, a Field Programmable Gate Array (FPGA) that can be programmed after manufacturing, or a reconfigurable processor. Some or all of the functions may be implemented by such a processor while some or all of the functions may be implemented by circuitry in any of the forms discussed above.

The present invention may be a non-transitory computer-readable recording medium having recorded thereon a program embodying the methods/algorithms discussed above for instructing a processor to perform the methods/algorithms.

Each of the elements of the present invention may be configured by implementing dedicated hardware or a software program controlling a processor to perform the functions of any of the components or combinations thereof. Any of the components may be implemented as a CPU or other processor reading and executing a software program from a recording medium such as a hard disk or a semiconductor memory.

It is also contemplated that the implementation of the components of the present invention can be carried out with any newly arising technology that may replace any of the above implementation technologies.

While this specification contains many specific implementation details, these should not be construed as limitations on the scope of any invention or of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a sub combination.

Similarly, while operations are depicted in the drawings in a particular order, this should not be understood as requiring that such operations be performed in the particular order shown or in sequential order unless otherwise noted, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter described in this specification have been described. Other embodiments are within the scope of the following claims. For example, the actions recited in the claims can be performed in a different order and still achieve desirable results, unless expressly noted otherwise. As one example, the processes depicted in the accompanying figures do not necessarily require the particular order shown, or sequential order, to achieve desirable results. In some implementations, multitasking and parallel processing may be advantageous.

Having thus described embodiments of the invention in rather full detail, it will be understood that such detail need not be strictly adhered to, but that additional changes and modifications may suggest themselves to one skilled in the art, all falling within the scope of the invention as defined by the claims.

What is claimed is:

1. A user interface (UI) for enabling a user to wirelessly control one or more Internet of Things (IoT) devices in a home or office from a mobile device, comprising:
an IoT protocol configured to discover and identify IoT devices in the home or office and generate a visual identifier for each IoT device;
an Indoor Positioning System (IPS) protocol configured to generate a location for each IoT device when the mobile device is pointed toward each IoT device;
an orientation sensor protocol configurated to generate orientation sensor data of the mobile device as it points to each IoT device;
an IoT device profile generated and stored for each IoT device comprising one or more of IPS data and the orientation sensor data; and
a filtering module configured to collect in real-time the IPS data and the orientation sensor data and to compare the collected data to the IoT device profile to generate a match for selecting one of the IoT devices for control options;
whereby the UI causes the mobile device to display the visual identifier and control options for the selected IoT device so that the user can control the IoT device through the mobile device.

2. The UI as recited by claim 1, wherein the UI is implemented and executed on the mobile device.

3. The UI as recited by claim 1, wherein the mobile device is a mobile phone.

4. The UI as recited by claim 1, wherein the UI is implemented through a gateway controller configured to establish a wireless streaming session between one or more access points and the mobile device, for generating the IoT device profile and executing the filtering module.

5. The UI as recited by claim 1, wherein the filtering module uses the orientation sensor data to filter the IoT device.

6. The UI as recited by claim 1, wherein the filtering module uses the IPS data to filter the IoT device, wherein the IPS data is used to identify the IoT device in a room in the home or office.

7. The UI as recited by claim 1, wherein the filtering module uses the IPS data and the orientation sensor data to filter the IoT device providing a position A with orientation X.

8. A method implemented by a user interface (UI) for enabling a user to wirelessly control one or more Internet of Things (IoT) devices in a home or office from a mobile device, the method comprising:
configuring an IoT protocol to discover and identify IoT devices in the home or office and generate a visual identifier for each IoT device;
implementing an Indoor Positioning System (IPS) protocol to generate a location for each IoT device when the mobile device is pointed toward each IoT device;
applying an orientation sensor protocol configured to generate orientation sensor data of the mobile device as it points to each IoT device;
generating and storing an IoT device profile for each IoT device comprising one or more of IPS data and the orientation sensor data;
collecting in real-time, by a filtering module, the IPS data and the orientation sensor data; and
comparing, in the filtering module, the collected data to the IoT device profile to generate a match for selecting one of the IoT devices for control options;
whereby the UI causes the mobile device to display the visual identifier and control options for the selected IoT device so that the user can control the IoT device through the mobile device.

9. The method as recited by claim 8, wherein the UI is implemented and executed on the mobile device.

10. The method as recited by claim 8, wherein the mobile device is a mobile phone.

11. The method as recited by claim 8, wherein the UI is implemented through a gateway controller configured to establish a wireless streaming session between one or more access points and the mobile device, for generating the IoT device profile and executing the filtering module.

12. The method as recited by claim 8, wherein the filtering module uses the orientation sensor data to filter the IoT device.

13. The method as recited by claim 8, wherein the filtering module uses the IPS data to filter the IoT device, wherein the IPS data is used to identify the IoT device in a room in the home or office.

14. The method as recited by claim 8, wherein the filtering module uses the IPS data and the orientation sensor data to filter the IoT device providing a position A with orientation X.

15. One or more non-transitory computer readable media having stored instructions which, when executed by a processor, cause the processor to enable a user interface (UI) for allowing a user to wirelessly control one or more Internet of Things (IoT) devices in a home or office from a mobile device, the instructions comprising steps for:
configuring an IoT protocol to discover and identify IoT devices in the home or office and generate a visual identifier for each IoT device;
implementing an Indoor Positioning System (IPS) protocol to generate a location for each IoT device when the mobile device is pointed toward each IoT device;
applying an orientation sensor protocol configured to generate orientation sensor data of the mobile device as it points to each IoT device;
generating and storing an IoT device profile for each IoT device comprising one or more of IPS data and the orientation sensor data;
collecting in real-time, by a filtering module, the IPS data and the orientation sensor data; and
comparing, in the filtering module, the collected data to the IoT device profile to generate a match for selecting one of the IoT devices for control options;
whereby the UI causes the mobile device to display the visual identifier and control options for the selected IoT device so that the user can control the IoT device through the mobile device.

16. The computer readable media as recited by claim 15, wherein the UI is implemented and executed on the mobile device and the mobile device is a mobile phone.

17. The computer readable media as recited by claim 15, wherein the UI is implemented through a gateway controller configured to establish a wireless streaming session between one or more access points and the mobile device, for generating the IoT device profile and executing the filtering module.

18. The computer readable media as recited by claim 15, wherein the filtering module uses the orientation sensor data to filter the IoT device.

19. The computer readable media as recited by claim 15, wherein the filtering module uses the IPS data to filter the IoT device, wherein the IPS data is used to identify the IoT device in a room in the home or office.

20. The computer readable media as recited by claim 15, wherein the filtering module uses the IPS data and the orientation sensor data to filter the IoT device providing a position A with orientation X.
